(19) United States
(12) Patent Application Publication
(10) Pub. No.: US 2009/0295400 A1
(43) Pub. Date: Dec. 3, 2009

(54) Electrostatic partricle sensor

(76) Inventor: Stefan Wilhelm, Freiburg im Breisgau (DE)

Correspondence Address: KENYON & KENYON LLP, ONE BROADWAY, NEW YORK, NY, 10004, US

(21) Appl. No.: 11/990,894

(22) PCT Filed: Jul. 17, 2006
(86) PCT No.: PCT/EP2006/064316

§ 371 Date: Jul. 13, 2009

(30) Foreign Application Priority Data
Aug. 24, 2005 (DE) 102005039915.0

(51) Int. Cl. G01N 27/60; G01N 27/62

(52) U.S. Cl. 324/452; 324/464

(57) ABSTRACT

An electrostatic particle sensor for sensing particles in exhaust gases includes: a lateral surface electrode having an effective flow volume, a gas flow to be tested flowing through it; an inner electrode situated inside the lateral surface electrode; and a voltage source which is in an electrically conducting connection with both electrodes. A potential which is dependent on the gas flow rate per time unit through the effective flow volume is impressed upon the voltage source.

### BACKGROUND OF THE INVENTION

1. Field of the Invention

The present invention relates to an electrostatic particle sensor.

2. Description of Related Art

The environmental pollution by fine particulate matter, in particular by soot particles which are produced during combustion processes of petroleum products, is on the increase. By improving the combustion technology of petroleum products, such as engine and heating system technologies, the particulate residues which remain from the oxidation process are considered increasingly critical for the environment due to highly reduced particle sizes.

Moreover, it is possible to evaluate the quality of the oxidation process based on the number and size of the particles in a defined exhaust gas volume. For example, it is known to use optical measuring methods for determining the exhaust gas quality. However, these methods have the disadvantage that they are subject to interference due to particle deposits on the sensor elements. Furthermore, gravimetric methods as well as methods based on mobility analysis are known in laboratories to determine in particular the number of soot particles, the mass of the soot particles, or the soot particle size distribution in combustion processes. Some of these methods have a complex design and have the additional disadvantage that the measurement does not take place directly in the exhaust gas system and therefore corruption of the measuring result is unavoidable, partly as a function of the age of the measuring gas due to chemical processes taking place in the measuring gas.

In contrast, improved measuring methods, i.e., direct measurement in the exhaust gas system, are known from published German patent documents DE 198 17 402 and DE 195 36 705. In DE 198 17 402, a plate-shaped capacitor is installed in an exhaust gas flow and heated to very high temperatures in the range of 500° C. to 800° C. to avoid soot deposits and measuring value corruptions associated therewith. This is supposed to eliminate a disadvantage, attributed to DE 195 36 705 A1, of a short circuit formation between two measuring electrodes situated in a measuring gas line.

The measuring methods described in both documents are based on the evaluation of an electrostatic field which is formed between two electrodes, is generated by a direct voltage source, and is changed by electric charges adhering to particles of an exhaust gas flow.

However, it is disadvantageous in both of these measuring methods that only particles having certain sizes which are in the range ascertainable by the particular sensor used based on the physical interrelations of the particular measuring method may be detected. Particles which are outside the particle size range detectable by the respective sensor cannot be detected with this measuring method. Complete quality information about the measured exhaust gas is thus not possible to obtain using these sensors.

### A BRIEF SUMMARY OF THE INVENTION

An object of the present invention is therefore to improve a particle sensor of the type described above.

Accordingly, the present invention relates to an electrostatic particle sensor which is characterized in that a potential, which is dependent on the gas flow rate per time unit through the effective volume of a lateral surface electrode, is impressed on a voltage source provided between the lateral surface electrode and an inner electrode situated within this lateral surface electrode for generating an electric field.

This approach is based on the finding that particles, in particular soot particles, having a different electrical mobility and thus a different mass and size, which are directly related thereto, may be detected by varying the electric field without having to modify the effective volume flow rate between the two measuring electrodes.

Of course, other parameters, such as the cross section and/or the length of the capacitor formed by the two electrodes, or the speed of the gas flow flowing through this system, may also be varied for detecting particles of different sizes. A particularly well manageable measuring range modification is provided for an appropriate particle measuring sensor by varying the potential of the voltage source causing the electric field.

It is considered as particularly advantageous here if the particle sensor is designed as a cylindrical capacitor, so that it is possible to accurately establish the volume that is effective for particle determination of the measuring gas by using defined geometric parameters. In addition, a cylindrical capacitor offers the possibility to detect particles having less mobility, i.e., greater mass, due to the radial dependency of the electric field contained therein for identical exterior dimensions and applied potential.

In addition to the geometric variables rₐ for the radius of the outer, i.e., lateral surface electrode, rᵢ for the radius of the inner electrode, of length 1, and potential U of the voltage source for generating the electric field, gas velocity V_{Gas} is also essential for establishing the parameters essential for this measuring method and thus also for establishing the particle size measuring range of the particle measuring sensor.

Therefore, a gas velocity measuring device which is most preferably designed as a non-invasive measuring device, a Venturi nozzle for example, is provided in a preferred specific embodiment. This makes it possible to determine the gas velocity without or at least without significant interference in the gas flow, which in turn has a positive effect on the measuring accuracy of the particle sensor. The measuring device may be situated either upstream or downstream from the electrode system in the direction of the gas flow.

Of course, measuring devices for determining the gas velocity in the form of a heat wire and/or a rotor and the like are also possible.

In contrast to example embodiments in which the effective volume flow is merely assumed on the basis of a presumed gas velocity, preferably a mean gas velocity, these example embodiments make it possible to further reduce system-related measuring errors by directly taking into account any velocity changes in the gas flow.

Of course, it is basically also possible to execute the measuring method through the sensor volume without directly detecting the velocity of the measuring gas flow; however, this saving is obtained through a comparatively lower measuring accuracy of the respective measuring sensor.

Due to the electric field between the two electrodes, i.e., preferably in the interior of the cylindrical capacitor, electrically charged particles, in particular soot particles contained in the exhaust gas, are accelerated either toward the outer electrode or toward the inner electrode as a function of their respective polarity. If the particles, in particular soot particles, strike an electrode, they give off their electric charge to this electrode. The charge given off by the charged particles to the electrode may be measured as current with the aid of a current measuring device, in particular via an electrometer. If the mean charge distribution of the particles is known, this is the mean charge per particle, and therefore the number of particles which have given off a charge to the electrode may be ascertained. The size of the particles is predefined by the above-discussed geometric conditions of the measuring system in conjunction with their electrical mobility.

The electric current detected by the electrometer thus corresponds to the electric charge which is transported by the particles of the particle flow in the measuring gas to be evaluated, for which the particle size measuring range is set.

Due to physical-chemical reactions in the measuring gas, a plurality of the particles contained therein is electrically charged. However, the charge distribution of the particles is not constant over time since charge exchange or neutralization takes place primarily through ion-ion recombination and the particles are predominantly neutral with increasing age of the measuring gas. It may therefore be necessary to ionize the soot particles by suitable ion sources as a function of the exhaust gas age. Direct or indirect high voltage-high frequency discharge, α, β, or γ radiation, electron radiation, or similar ionization sources are preferably provided for this purpose.

Furthermore, deposits in the measuring system could be removed in order to avoid measuring errors by using a heating device, preferably by burning them.

### A BRIEF DESCRIPTION OF THE SEVERAL VIEWS OF THE DRAWING

FIG. 1 shows a schematic representation of a first example embodiment of an electrostatic particle sensor.

FIG. 2 shows a second example embodiment modified with respect to the first example embodiment.

FIG. 3 shows a diagram for parametric representation of the electrical limit mobility of the particles of a measuring gas as a function of the radii ratios of a lateral surface or outer electrode to an inner electrode of the measuring systems according to FIGS. 1 and 2.

FIG. 4 shows the cross-section surface of the measuring system, also as a function of the radii ratios.

### DETAILED DESCRIPTION OF THE INVENTION

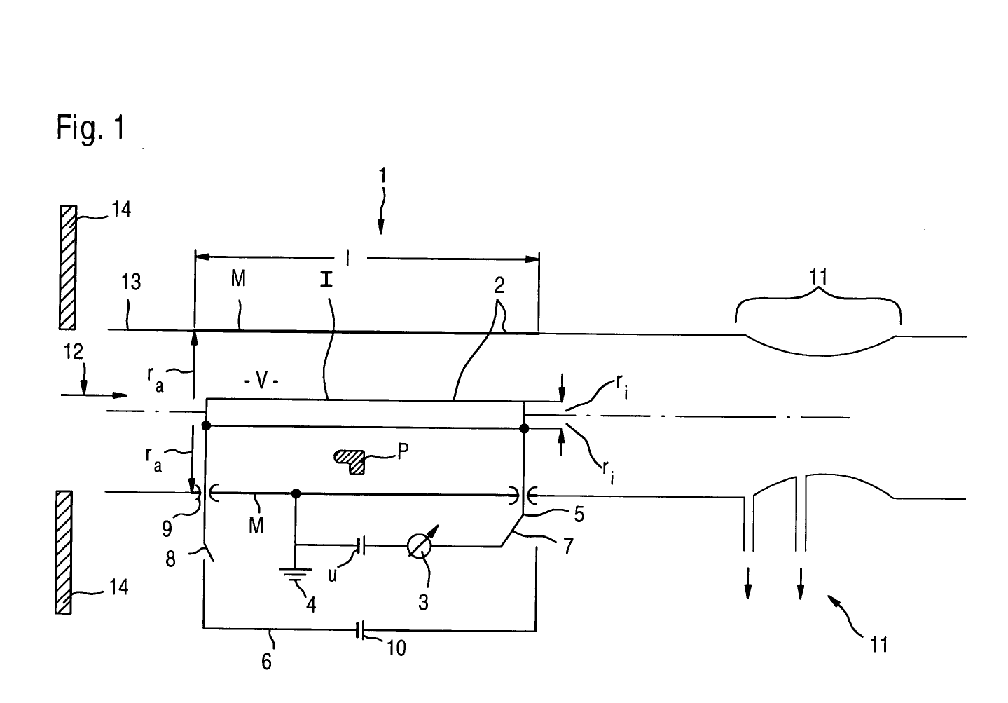

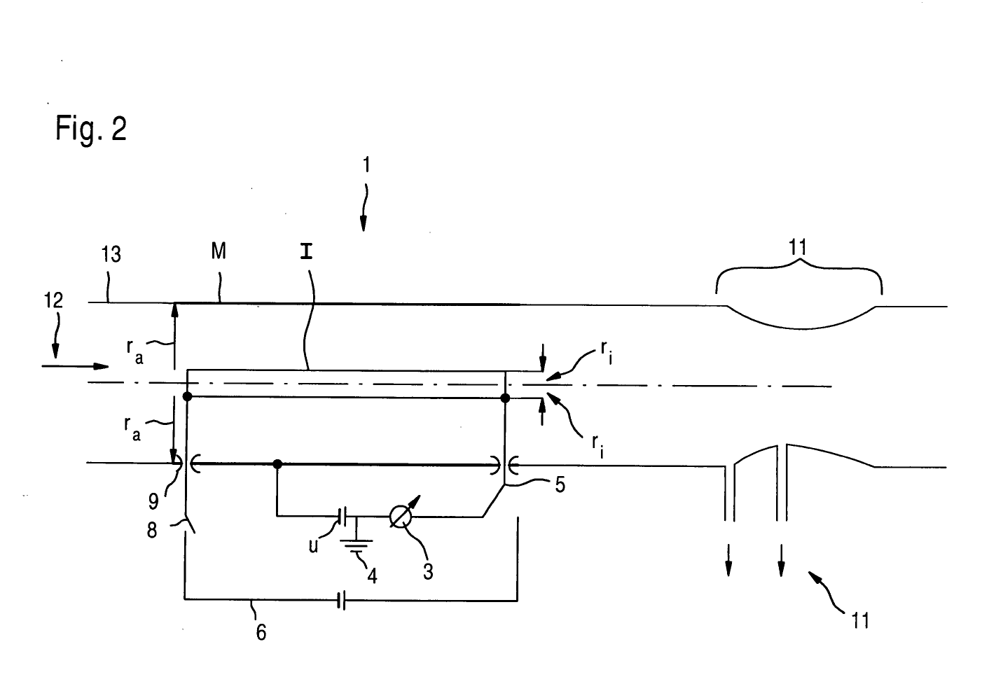

FIGS. 1 and 2 show two exemplary, symbolically represented configurations of electrostatic sensors for measuring particles in aerosols, in particular for measuring soot particles in exhaust gases, the exhaust gases being preferably exhaust gases of diesel engines.

Such sensors may be provided as sturdy measuring devices for analyzing soot particles directly in the exhaust gas system so that, on the one hand, they are suitable to be operated in a shop and, on the other hand, for direct installation in a respective vehicle for improving the exhaust gas quality and basically for improving the engine properties.

Another possible area for the use of such sensors is the field of heating technology. Here also, mobile as well as immobile applications may be provided. In mobile applications, the instantaneous exhaust gas values of a heating system may be determined, for example. In immobile applications, a direct effect on the regulation process of the heating system is conceivable, so that possibly a great savings potential in fuel consumption may be achieved by measures being initiated according to the soot formation.

FIG. 1 shows in detail a first example embodiment of an electrostatic particle sensor 1 for sensing particles P in aerosols, in particular for sensing soot particles in exhaust gases. This sensor, designed as a cylindrical capacitor and including a lateral surface or outer electrode M and an inner electrode I, is equipped with a voltage source U for supplying electrodes M and I. The potential of this voltage source U may be set according to the present invention as a function of the gas flow rate per time unit through volume V between both electrodes M, I and a particle size to be detected. This makes it possible to provide a variable measuring range for particles of different sizes using one and the same measuring configuration.

Due to the geometric parameters of the capacitor, the strength of the electric field, and the velocity of the gas in the capacitor, only particles having a certain electrical mobility reach the inner or outer electrode for discharging their adhering electric charge as evidence of their existence in the gas flow to be measured.

Geometric parameters rₐ and rᵢ of cylindrical capacitor 2 together with its length 1 determine volume V effective for the measuring method. In this embodiment, inner electrode I is connected to the variable potential of voltage source U via an electrometer 3. The ground of this voltage source is connected to the outer electrode which, if needed, may also be connected to a vehicle chassis 4.

Lateral surface electrode M of cylindrical capacitor 2 having a tube-shaped design has a temperature resistant, insulated lead-through 5 for the electrical connection between electrometer 3 and inner electrode I.

To ensure that the measuring results obtained using this measuring system are not corrupted due to deposits during the service life on inner electrode I and/or the electrical connection between the electrometer and inner electrode I and due to the associated conductivity changes, a heating circuit 6 is additionally provided which may be closed via switches 7, 8. Heating circuit 6 is closed through a second, temperature-independent and insulated lead-through 9 formed in outer electrode M toward inner electrode I.

In order to avoid interferences in the measuring result, parts of this circuit are heated in appropriate time intervals to such an extent that adhering particles, in particular soot particles, are burnt off. If needed, such heating periods may be carried out in a timed manner, preferably with no measurement taking place during the heating period in order to suppress any interference caused by it. The heating circuit is supplied by another voltage source 10.

For determining the gas velocity by the measuring system, a gas velocity measuring device is furthermore provided which, in the present case, is particularly preferably designed as a non-invasive measuring device in the form of a Venturi nozzle.

This makes it possible to determine the particle size of particles P as a function of the gas velocity, the geometric relationships of the measuring system, and the strength of the electric field based in the measured electrical current which is caused by the electric charge transmitted by particles P.

The flow direction of the gas flow through the measuring system is indicated by arrow 12 which is symbolically shown at the entrance of exhaust gas pipe 13 between two elements 14 representing an ionization source. Ionization source 14 may preferably be designed as a high-voltage source and/or a high-frequency source.

The advantage of this embodiment is that the outer electrode is connected to ground and may be implemented directly into an exhaust gas system 13 without insulation. The maximum possible potential of the voltage source is limited by the electronics of the electrometer.

In contrast, the outer electrode is connected to the variable potential of voltage source U in the modified example embodiment in FIG. 2. The inner electrode discharges toward ground via the electrometer. The advantage in this specific embodiment is that there is no limitation of the maximum possible potential by the electronics of the electrometer. In contrast to the embodiment in FIG. 1, however, an insulation of lateral surface or outer electrode M against the exhaust gas system must be provided.

The following measuring modes are possible using this example embodiment:
1. Measuring the number of all diesel soot particles: Operation at constant potential Uₘₐₓ, corresponding to the design of the “electrostatic probe for measuring diesel soot” all particles with k>kₗᵢₘᵢₜ are detected.
2. Measuring of mobility (mass, size) distribution: Potential U is increased stepwise from U=0 V to U=Uₘₐₓ. The interval between the steps and the durations of the measuring steps determine the resolution of the distribution.

Since all charged soot particles having k>kₗᵢₘᵢₜ are detected during the measurement, the number of soot particles per mobility interval must be ascertained by differentiation.

By reversing the polarity of applied potential U, either positively or negatively charged soot particles may be measured.

If the outer radius, the inner radius, the length of the electrodes, the applied potential, and the velocity of the gas v_{gas} are given, the following limit mobility kₗᵢₘᵢₜ results:

$${k}_{limit} = \frac{1}{l U} {v}_{gas} In ( \frac{{r}_{a}}{{r}_{i}} ) \frac{1}{2} ( {r}_{a}^{2} - {r}_{i}^{2} )$$

The limit mobility determines the minimum mobility which a charged particle is allowed to have in order to, with given parameters (U, l, rₐ, rᵢ, v_{gas}), still be accelerated toward the inner electrode within the length of stay in the field of the “electrostatic sensor for measuring diesel soot.” As a function of the calibration, the parameters (Uₘₐₓ, l, rₐ, rᵢ, v_{gas}) may be adapted in order to determine the intended sensitivity, the resolution capability, and the bandwidth of the “electrostatic sensor for measuring diesel soot.”

In order to be able to preferably detect all diesel soot particles (also those having large masses) it is necessary to achieve preferably low limit mobility kₗᵢₘᵢₜ via dimensioning of the parameters (Uₘₐₓ, l, rₐ, rᵢ). This limit mobility is determined to a high degree by the ratio d=rₐ/rᵢ since, in most applications, Uₘₐₓ and l are limited by technical boundary conditions. In contrast, the detection sensitivity of the probe is determined to a high degree by cross-section surface A.

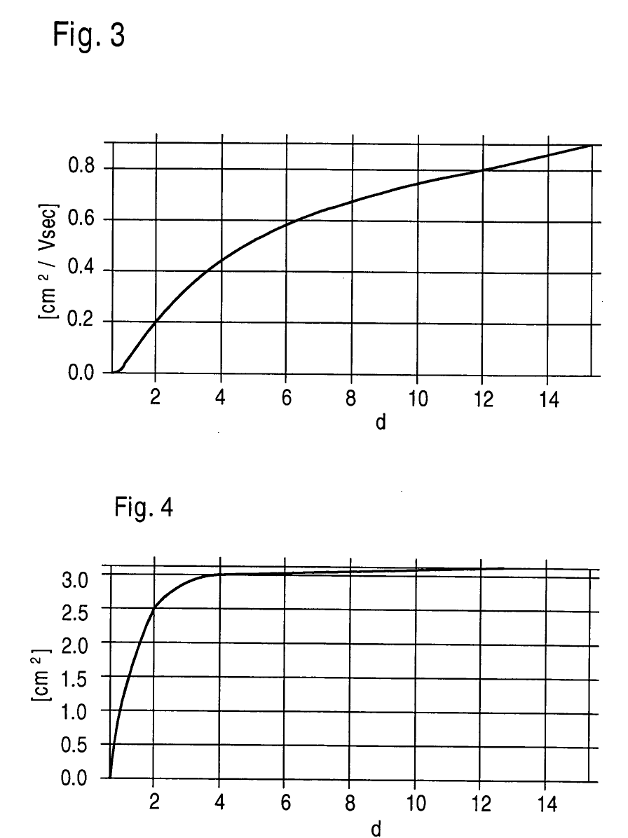

FIGS. 3 and 4 show a representation of parameters kₗᵢₘᵢₜ and A as a function of d=rₐ/rᵢ. FIG. 3 shows a diagram of the parameter electrical limit mobility of the particles as a function of the radii ratios of a lateral surface or outer electrode to an inner electrode of the measuring systems according to FIGS. 1 and 2.

During the measuring process with potential difference U applied between lateral surface or outer electrode M having radius rₐ and inner electrode I having radius rᵢ, the measurement may be carried out in the gas flow to be measured by taking into account electrical mobility k of the particles. Electric field E is formed between both electrodes perpendicular to the direction of movement of the gas (inhomogenieties of electric field E at the edges of the electrodes may largely be neglected). Depending on the polarity, charged particles are accelerated in the electric field either toward the outer electrode or toward the inner electrode. This results in constant velocity component u=k·E(r) perpendicular to the electrode axis as a function of electrical mobility k of the particles.

Knowing the charge distribution on the (soot) particles makes it possible to calculate the number of particles whose electrical mobility is greater than kₗᵢₘᵢₜ.

It is possible to calculate a mobility spectrum by varying the applied potential difference.

With the aid of the relation:

$$k ( m ) = 11.2 \cdot {m}^{- 0.415} \cdot \frac{T \cdot 1013}{p \cdot 273} [ \frac{{cm}^{2}}{V \cdot s} ]$$

(from W. D. Kilpatric, “An experimental mass-mobility relation for ions in air at atmospheric pressure.” Proc. 19^{th} Ann. Conf. on Mass Spectroscopy, page 320, 1971) it is possible to determine the mass of the particles from the measured electrical mobility.

In addition, by assuming a mean density and geometrical shape of the soot particles it is possible to determine their size.

1-10. (canceled)

11. An electrostatic particle sensor configured for sensing particles in an exhaust gas, comprising:
a lateral surface electrode having an effective flow volume, wherein a gas flow to be tested flows through the lateral surface electrode;
an inner electrode situated inside the lateral surface electrode; and
a voltage source in an electrically conducting connection with both the lateral surface electrode and the inner electrode, wherein a potential which is dependent on the gas flow rate per time unit through the effective flow volume is impressed upon the voltage source.

12. The sensor as recited in claim 11, wherein the sensor is configured as a cylindrical capacitor.

13. The sensor as recited in claim 11, further comprises:
a gas velocity measuring device.

14. The sensor as recited in claim 13, wherein the gas velocity measuring device is configured as a non-invasive measuring device.

15. The sensor as recited in claim 13, wherein the gas velocity measuring device is configured as a Venturi nozzle.

16. The sensor as recited in claim 13, wherein the gas velocity measuring device includes at least one of a heat wire and a vane.

17. The sensor as recited in claim 13, further comprising:
a current measuring device.

18. The sensor as recited in claim 17, wherein the current measuring device measures an electric current caused by an electric charge which is transported by a particle flow of electrically charged particles moving between the lateral surface electrode and the inner electrode.

19. The sensor as recited in claim 17, further comprising:
an ionization source.

20. The sensor as recited in claim 19, wherein the ionization source is configured as at least one of a high-voltage source and a high-frequency source.
